(19) United States
(12) Patent Application Publication
(10) Pub. No.: US 2007/0271028 A1
(43) Pub. Date: Nov. 22, 2007

(54) Method and Apparatus for Vehicle Safety Surveillance

(76) Inventors: Zicheng Liu, Bellevue, WA (US); Zhongfei Zhang, Vestal, NY (US)

Correspondence Address: ZICHENG LIU, 14743 SE 63RD STREET, BELLEVUE, WA, 98006, US

(21) Appl. No.: 11/383,958

(22) Filed: May 18, 2006

(51) Int. Cl. G06F 19/00

(52) U.S. Cl. 701/120; 348/143

(57) ABSTRACT

This invention addresses the problem of the safety surveillance of a vehicle parked in a place where the host of the vehicle is absent. When a vehicle is parked, it may be damaged either maliciously or accidentally. This invention describes a method and apparatus that automatically detect any compromise to the vehicle safety and send alert messages to the host. In addition, the method and the apparatus keep video recordings of any event when a compromise to the vehicle safety occurs that can be used to track down the whole event.

### DEFINITION

A vehicle is any automobile that may operate on the road, including but not necessarily limited to all different cars, all different trucks, all different vans, all different motorcycles, and all different buses.

A host of a vehicle is any individual related to this vehicle, who may be either the legal owner of the vehicle, or the current driver of the vehicle, or a passenger of the vehicle.

Vehicle safety here refers to preventing the scenario where a vehicle in a parking place is damaged maliciously or accidentally.

### DESCRIPTION

According to 2004 National Statistics Report released by the National Center for Statistics and Analysis of US Department of Transportation [1], the total number of the police-reported vehicle damages in 2004 was 4,281,000, most of which happened in the parking space. It was also estimated that the number of the total non-police-reported vehicle damages could even be higher [2].

When a vehicle is in operation on the road, people normally have conscious attention to exercise a full control of the vehicle to stay away from a potential damage. That is why most of the road damages come from unconscious drivers such as DWI. However, when a vehicle is parked in a parking space and is away from the attention of the host, there is no way to avoid any malicious or accidental damages. This fact explains that most of the damages come from the parking space where the damaged vehicles are not in operation on the road.

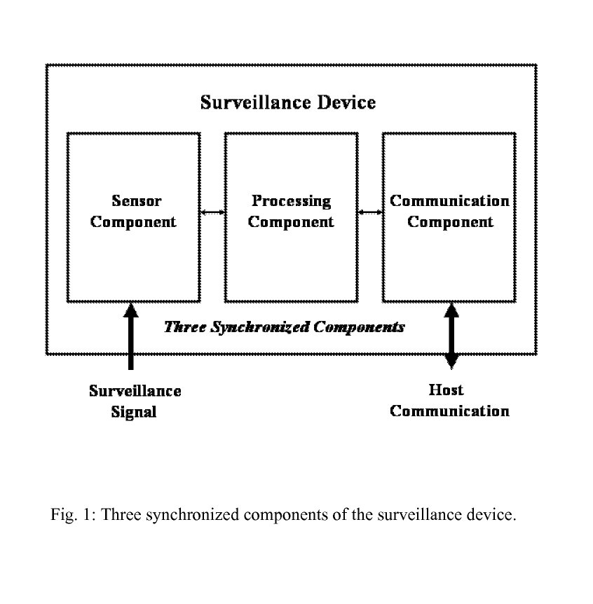

Motivated by this consideration, we invent an automatic surveillance method as well as the related apparatus that prevents and records any potential damages to a vehicle in a parking space without the attention of the host of the vehicle for the vehicle safety concern. The method and the apparatus consist of a surveillance device and software. The surveillance device consists of three synchronized components: a sensor component, a processing component, and a communication component. FIG. 1 illustrates the three components of the surveillance device. The functionalities of these components as well as the invented scenario are described as follows.

When a vehicle is parked in a place (which may be but not necessarily limited to a public parking space, on the street, in front of a building including a private house), the sensor component of the surveillance device monitors the surrounding environment of the vehicle all the time including day and night for the vehicle safety concern. The sensor component is a combination of several types of sensors including video camera, infrared camera, motion detection sensors, etc.

Whenever the sensor component is in operation, the processing component also works in synchronization with the sensor component. There are three functionalities for the processing component. The first functionality is to intelligently and automatically schedule the switch between different types of the sensors at different times (e.g., the sensors used in the daytime are different from those used in the night). The second functionality is to provide the online processing of the sensor data to detect any potentially committed compromise to the vehicle safety (the detailed detection algorithm is filed separately as another invention). The synchronized operation between the sensor component and the processing component ensures the detection of any type of the potentially committed compromise to the vehicle safety. The third functionality is to provide indexing to the recorded video to allow fast browsing. In case the method fails to detect a compromise to the vehicle safety, the host can browse the recorded video and find out what has happened. Linearly browsing the video is extremely time-consuming. Our method creates indexing based on the analysis of the sensor signals. This allows nonlinear browsing which is much more efficient.

When there is an actually committed compromise to the vehicle safety (e.g., a collision from other vehicles to this vehicle or a manual scratch by a human being to this vehicle), the processing component of the surveillance device shall immediately detect such committed compromise and shall record and document the whole visual process of such committed compromise. In addition, at the first moment when such committed compromise is initiated, the synchronized communication component of the surveillance device shall immediately send an alert message to one or all of the hosts of the vehicle depending on how the alert sending pattern is set. The communication of this alert message is sent through a wireless channel from the surveillance device installed in the vehicle to a reception device of the hosts. The reception device of the hosts may be but not necessarily limited to cell phone, or personal computer. Once the hosts receive the alert message, they may request the surveillance device through the communication component to view the scene online recorded and documented by the processing component of the surveillance device on the spot. This functionality of online viewing helps the hosts determine whether this specific alert is for a real committed compromise to the vehicle safety or just a false alarm. If it is a real committed compromise to the vehicle safety, this functionality of online viewing further helps the hosts decide whether this committed compromise to the vehicle safety actually results in damage to the vehicle, and if this is the case, how serious the damage is. This information is helpful in the hosts' further decision-making regarding whether to take further actions including legal actions, such as but not necessarily limited to reporting the accident to the police and/or saving the online scene transmitted over from the communication component of the surveillance device. The saved footages can be used as legal evidence for subsequent legal actions.

### REFERENCES

[1] Traffic Safety Fact 2004, National Center for Statistics and Analysis, US Department of Transportation, Washington, D.C.,

[2] http://www.nhtsa.dot.gov/

Wherefore, what is claimed is:

1: A surveillance method and apparatus for a parked vehicle where the host of the vehicle is away from the vehicle that comprises one or more of the following actions:
(1) detects any compromise to the vehicle safety;
(2) sends alert message to the host;
(3) records audio, video, and other sensory information;
(4) computes indexing based on data analysis to allow fast browsing of the recorded content.

2: The apparatus in claim#1 that comprises a hardware device which consists of a sensor component, a processing component, and a communication component.

3: The apparatus in claim#2 wherein the sensor component comprises any combination of the following types of sensors:
(1) one or multiple video cameras.
(2) one or multiple microphones,
(3) one or multiple motion sensors
(4) one or multiple infrared video cameras
(5) any other type of sensors that are capable of detecting noises, motions, or vibrations.

4: The apparatus in claim#2 wherein the communication component uses one or a combination of multiple of the following communication methods:
(1) Cell phone network
(2) Internet
(3) WiFi network
(4) Any form of Local Area Network

5: The apparatus in claim#2 wherein the processing component is able to intelligently and automatically switch to using different types of sensors due to the following environmental changes:
(1) changes between day and night
(2) changes of the visibility including occlusion

6: The apparatus in claim#2 wherein the processing component is capable of detecting any type of compromise to the vehicle safety.

7: The apparatus in claim#2 wherein the processing component is capable of immediately recording the audio and video footage and other sensory information once any type of compromise to the vehicle safety is detected.

8: The apparatus in claim#2 wherein the processing component is capable of indexing the recorded information such that the host of the vehicle is able to browse the recorded video footage through the communication component in claim#4.

9: The apparatus in claim#2 wherein the processing component is capable of indexing the recorded video footage such that the host of the vehicle is able to immediately retrieve and view a specific video clip of all the recorded footage through the communication component in claim#4.

10: The apparatus in claim#2 wherein the three components are synchronized such that
(1) the processing component immediately detects any compromise to the vehicle safety through the signals in the sensor component; and
(2) the communication component immediately sends an alert message to the host or the hosts of the vehicle once the processing component detects a compromise to the vehicle safety.

11: The method and apparatus in claim#1 wherein the compromises to the vehicle can be any of the following:
(1) collision of any other vehicle with the vehicle concerned, either maliciously or accidentally;
(2) scratch or any similar damage to the vehicle body either maliciously or accidentally;
(3) damage caused by any unpredictable natural disaster such as tornado or icy thunderstorm.

12: The method and apparatus in claim#1 wherein a parked vehicle may refer to any of the following parking space:
(1) public parking lots
(2) private parking area
(3) street parking

13: The method and apparatus in claim#1 wherein the recorded data are stored in a hard disk, a tape, or any other storage devices.

14: The method and apparatus in claim#1 wherein the recorded data are accessible by a remote device.

15: The method and apparatus in claim#1 wherein the different sensors are installed at different locations of the vehicles.

16: The apparatus in claim#2 wherein one or more of the components are built in to the vehicle.

17: The method and apparatus in claim#1 wherein the vehicles are any types of automobiles including:
(1) passenger cars
(2) mini vans
(3) buses
(4) motorcycles
(5) trucks

18: The apparatus in claim#2 wherein the power is supplied by a battery or by using the power supply of the vehicle.

19: The apparatus in claim#2 wherein the sensor component communicates with the processing component either through wired channels or through wireless channels.

20: The apparatus in claim#19 wherein the sensor component is powered either by a battery or by using the power supply of the vehicle.
